(19) United States
(12) Patent Application Publication
(10) Pub. No.: US 2005/0234988 A1
(43) Pub. Date: Oct. 20, 2005

(54) Message-based method and system for managing a storage area network

(76) Inventor: Randall E. Messick, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/825,207

(22) Filed: Apr. 16, 2004

(51) Int. Cl. G06F 17/00

(52) U.S. Cl. 707/104.1

(57) ABSTRACT

A method, and a corresponding system, provide for managing a storage area network (SAN). The method includes the steps of receiving an alert related to a state of a device coupled to the network, parsing the alert to identify the state of the device, identifying action required in response to the identified state of the device, and identifying a notification message. The notification message provides information related to the state of the device.

### TECHNICAL FIELD

The technical field is systems used for managing storage assets in a distributed computer system.

### BACKGROUND

Computer systems typically use one of three types of storage systems: direct attached storage (DAS), network attached storage (NAS), and storage area network (SAN) systems. SAN systems are capable of providing fast access to large amounts of data, but require specific management functions in order to operate in an optimum manner.

In current computer systems, SAN management functions may be under control of a storage management application. Such a storage management application requires frequent human user interaction. Extra administrators must be available to react to problems that may arise during operation of the computer system, and in particular, during operation of the computer system's storage sub-system. If these administrators are not available, or if the administrators are not empowered to resolve storage and network problems, delays in reconfiguring the SAN for optimum performance may occur. For example, if a database exceeds its allocated storage capacity, an administrator must be informed immediately or there is a risk that an application will “crash.” The administrator, before allocating additional storage, may first have to obtain approval from finance to pay for extra storage, which may need to be signed for by another layer of management, before the allocation of the extra storage occurs. Finding the right people may be difficult and time consuming, and may result in delays in obtaining the storage. Such delays may result in system downtime, and lost business opportunities.

### SUMMARY

What is disclosed is a method for managing a storage area network (SAN). The method includes the steps of receiving an alert related to a state of a device coupled to the network and parsing the alert to identify the state of the device. The parsing step includes determining a problem category and determining action options by consulting an action rules database. The method further includes identifying action required in response to the identified state of the device and identifying a notification message. The notification message provides information related to the state of the device.

Also disclosed is a system for managing a storage area network (SAN). The system includes a management server that monitors states of devices coupled to the SAN and sends alert messages based on the states and a message processor that receives the alert messages and sends notification messages. The message processor includes a receiver that receives the alert messages, a parser that analyzes the received alert messages, a formatter/addresser that formats and addresses the notification messages, and a transmitter that sends the notification messages to messaging devices.

Further what is disclosed is a computer program product including a computer-readable medium and computer-readable code embodied on the computer-readable medium. The computer-readable code is configured to cause a computer to execute the steps of receiving an alert related to a state of a device coupled to a storage area network (SAN) and parsing the alert to identify the state of the device. Parsing the alert includes determining a problem category, and determining action options, comprising consulting an action rules database. The steps executed by the computer further includes identifying action required in response to the identified state of the device, and identifying a notification message, wherein the notification message provides information related to the state of the device.

Finally, what is disclosed is message-based system for managing a storage area network (SAN) including means for monitoring states of devices coupled to the SAN; means for sending alert messages based on the states and means for receiving the alert messages and sending notification messages. The receiving means includes means for analyzing the received alert messages, and means for formatting and addressing the notification messages, wherein the notification messages are sent to messaging devices.

### DESCRIPTION OF THE DRAWINGS

The detailed description will refer to the following figures in which like numerals refer to like items, and in which:

FIG. 1A is a block diagram of an exemplary highly available storage area network (SAN) system;

FIG. 1B illustrates a physical implementation of the SAN system of FIG. 1A;

FIG. 1C is a block diagram of an embodiment of a message-based storage management system adapted for use with the SAN system of FIG. 1A;

FIG. 1D illustrates a device status summary used with the SAN system of FIG. 1A;

FIG. 1E is a block diagram of a management server used in the system of FIG. 1A;

FIG. 1F illustrates an embodiment of assignment rules used with the SAN system of FIG. 1A;

FIG. 2 is a block diagram of an embodiment of a message processor used with the system of FIG. 1A;

FIG. 3 illustrates a message processed by the message processor of FIG. 2;

FIG. 4A illustrates an embodiment of a programs executed by the message processor of FIG. 2 to manage a SAN system;

FIGS. 4B and 4C illustrate an embodiment of a message parsing algorithm used by the message processor of FIG. 2;

FIG. 4D illustrates an embodiment of a message formatting and addressing algorithm used with the message processor of FIG. 2; and

FIG. 5 is a diagram of the data structure of a lightweight directory access protocol database used by the message processor of FIG. 2.

### DETAILED DESCRIPTION

A storage area network (SAN) provides shared storage by creating a network of storage devices separate from a standard Ethernet LAN, and letting servers access that shared storage. At its most basic level, a SAN is defined as a dedicated fibre channel network of interconnected storage and servers that offers any-to-any communication between these devices and allows multiple servers to access the same storage device independently. One key advantage to network-based storage (i.e., a SAN) is that storage resources are shared among many servers or hosts. Such shared storage eliminates the normal excess storage capacity found in direct-attached storage (DAS) systems. Furthermore, within limits, any server can access any storage device through the SAN. The result is less “required” excess storage capacity, the ability to switch storage, and better storage backup options.

SANs may connect to hosts using fibre channel. Fibre channel is a scalable data channel designed to connect heterogeneous systems and peripherals. Fibre channel enables almost unlimited numbers of devices to be interconnected and allows the transportation of different protocols simultaneously. Fibre channel also supports speeds up to five times that of current protocols and distances of up to 10 kilometers between system and peripheral.

SANs are usually built on a switched fiber channel network and data are stored and served at the block level. Block-based access deals with managing volumes, or blocks, of data, with less importance placed on identifying individual files on a disk. In its most basic application, block-based access provides high-speed access to large quantities of data. Block-based access is optimally used when the objective is to consolidate storage and data and then duplicate, back up, or otherwise manage the data en masse. Hence, SANs provide fast access to large quantities of data, such as order processing or ERP.

A computer system having a SAN may include a storage management system to control operations of the SAN and to optimize allocation of SAN resources. SAN resources may include hosts, bridges, storage devices, and interconnect devices. Hosts may be servers or personal computers.

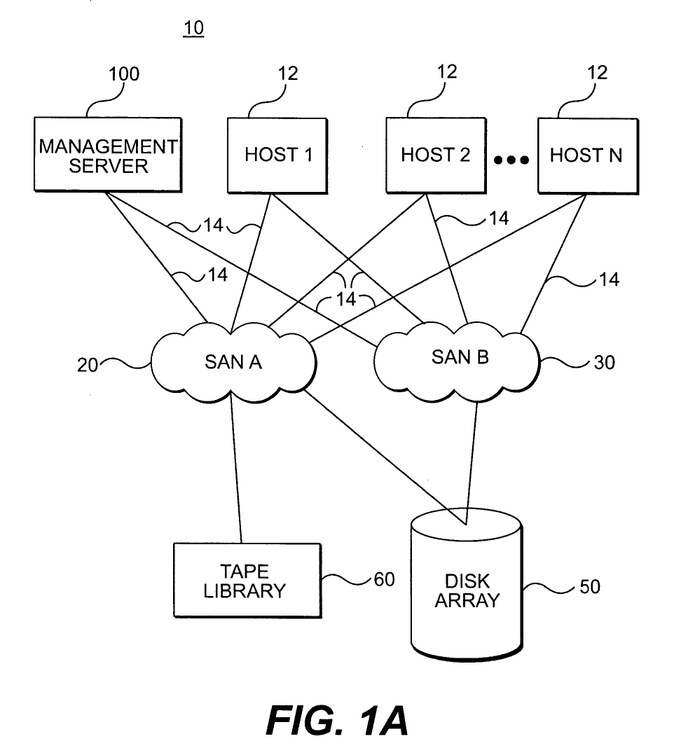

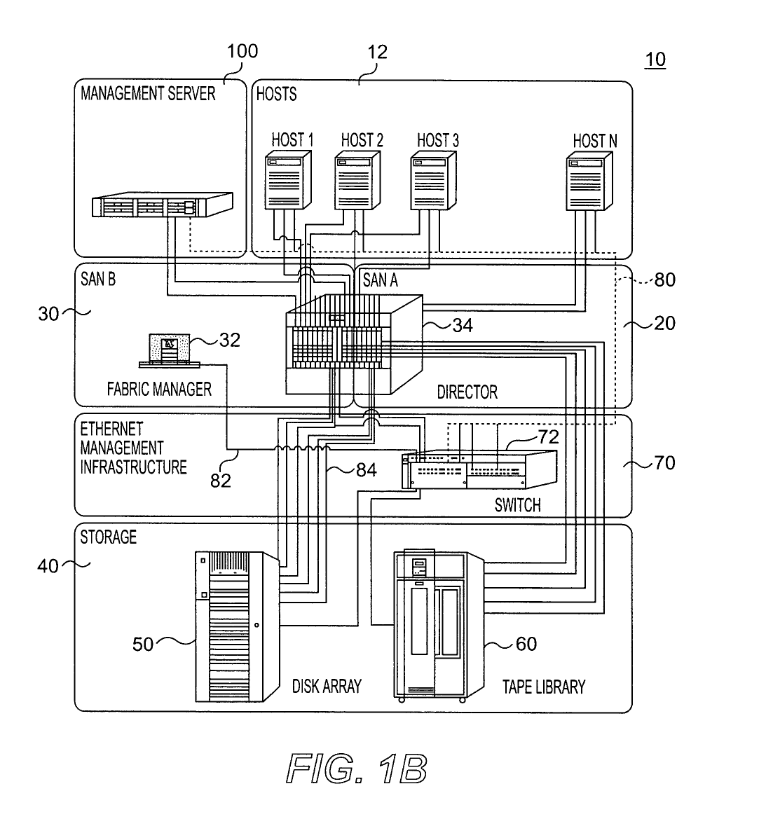

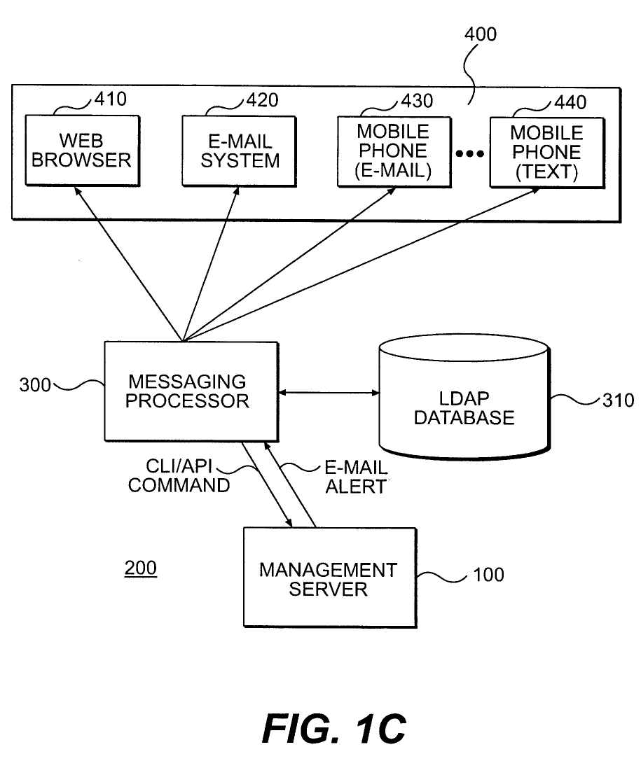

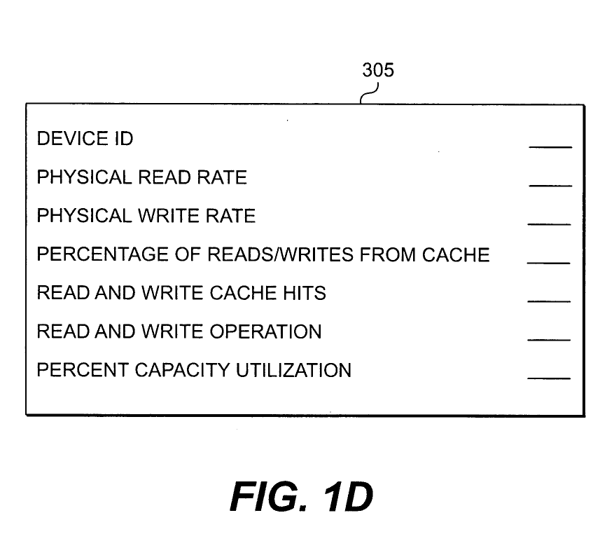

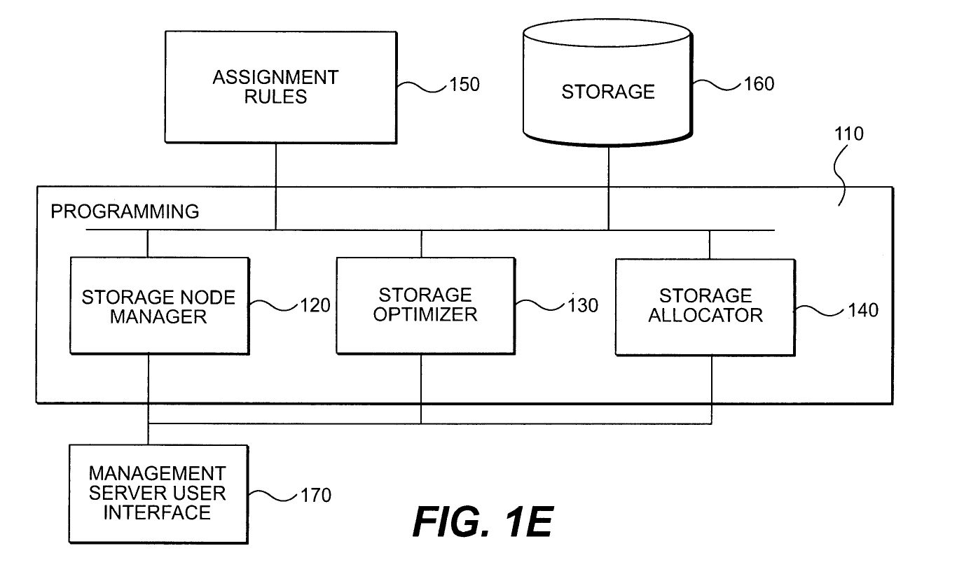

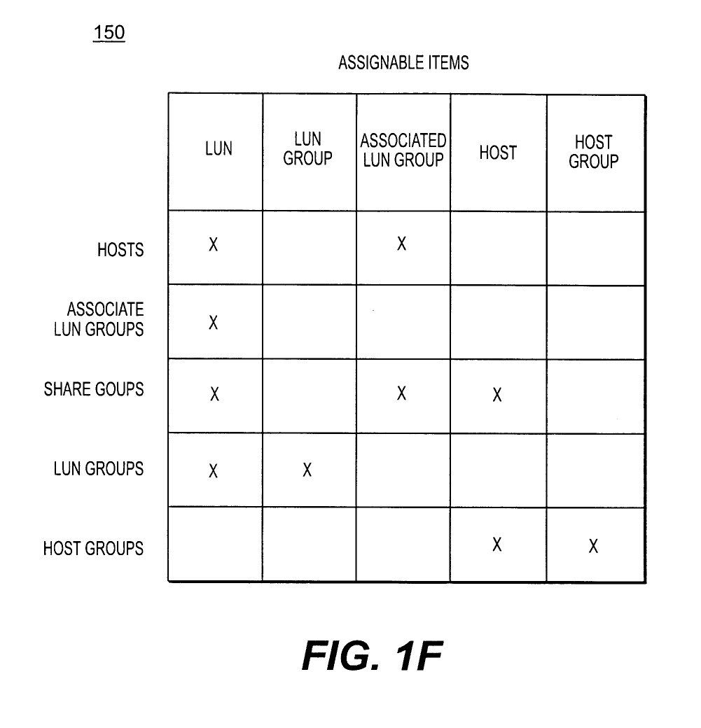

FIG. 1A is a block diagram of an exemplary storage (SAN) system 10 that incorporates use of SANs. In FIG. 1A, SAN system 10 includes SANs 20 and 30 coupled to hosts 12, disk array 50, tape library 60, and management server 100. A large number of hosts 12 may connect to the SANs 20 and 30. For example, up to 50 hosts may connect to the SANs 20 and 30. The hosts 12 may connect to the SANs 20 and 30 using fibre channel 14.

FIG. 1B illustrates a physical implementation of the exemplary SAN system 10. In FIG. 1B, hosts 12 (host 1-host N) use networked storage 40, including disk array 50 and tape library 60. To connect the storage 40 and the hosts 12, the SAN system 10 includes SAN A 20 and SAN B 30. The SAN system 10 includes a number of interconnect devices, such as Ethernet management infrastructure 70, which includes Ethernet LANs 80 and 82, and Ethernet switch 72, fibre channel 84, fabric manager 32 and SAN director 34. To manage storage access, the SAN system 10 includes management server 100. Except for the hosts 12, the components shown in FIG. 1B can be rack mounted in a single enclosure.

The management server 100 automatically discovers hosts, interconnect devices, bridges, and storage devices in the SAN system 10. The management server 100 also monitors the health and state of the devices in the SAN system 10. Using SAN system 10 components, which will be described in detail later, a system administrator (i.e., a human operator) can be kept current with the storage system configuration, can ensure that storage is assigned automatically, quickly, and without interruptions, can be told ahead of time if storage capacity may be exceeded, can be assured that storage is used efficiently and at the lowest possible costs, and can identify and remove bottlenecks that would otherwise impede system performance. To provide these improvements over current systems, a message-based storage management system works in conjunction with the management server 100 to analyze problems, initiate recovery actions, and provide information to appropriate system operators and administrators.

FIG. 1C is a block diagram of a message-based storage management system 200 adapted for use with the SAN system 10. The system 200 includes a message processor 300. The message processor 300 is coupled to the management server 100, a lightweight directory access protocol (LDAP) database 310, and messaging devices 400. The message processor 300 receives e-mail alert messages from the management server 100 and returns command line interface (CLI)/application programming interface (API) commands. The e-mail alerts are messages related to a status of one or more of the devices used in the SAN system 10 of FIG. 1A. For example, an e-mail alert from the management server 100 may indicate when the tape library 60 is at 90 percent capacity. Other e-mail alerts may be provided to indicate a security breach, an under capacity condition of a storage device, a failed interconnect device or bridge, out of band performance metrics, and trend analysis of performance metrics, for example. One of ordinary skill in the art will recognize that many other conditions related to the health and service of the devices shown in FIG. 1A can result in the management server 100 generating an e-mail alert. As an alternative to e-mail messaging, the management server 100 may send alerts to the message processor 300 using short messaging service (SMS) messages or network messages, for example. One of ordinary skill in the art will recognize many additional means for sending alerts to the message processor 300.

The message processor 300 may return CLI/API commands to the management server 100 in response to the received e-mail alerts. The message processor 300 may generate the commands automatically (i.e., without human intervention) using a set of action rules. For example, the action rules may allow the message processor to initiate the following: restart of a service (or services) upon failure, reboot a server upon failure, launch an executable or batch command job, launch a VBScript, place a backup storage device online. The message processor 300 may also generate commands based on directions from a human operator.

The message processor 300 may send messages related to the health or state of any of the devices of FIG. 1A, based on a received e-mail alert from the management server 100. The message processor 300 can send the messages to one of many devices 400, including a web browser 410, an e-mail system 420, a mobile phone (voice) 430 and a mobile phone (text message) 440. Many other devices are capable of receiving messages from the message processor 300, including conventional telephones, televisions, and many other devices capable of receiving analog or digital communications.

When sending a message to the devices 400, the message processor 300 consults the LDAP database 310, for example. Other types of databases may also be used. As will be described later in detail, the LDAP database 310 contains identities and contact information for individuals responsible of the operation and maintenance of the SAN system 10 of FIG. 1A.

FIG. 1D illustrates a device status summary 305 used with the SAN system 10. The device status summary 305 may identify a device using, for example, a device ID. The summary 305 may also include one or more metrics related to performance of the device, examples of which are shown in FIG. 10.

FIG. 1E is a block diagram of programming 110 used with the management server 100. The programming 110 includes storage node manager 120, storage optimizer 130, and storage allocater 140. Associated with the programming 110 are assignment rules 150 and storage 160.

Storage node manager 120 is a device status monitoring tool for the SAN. The storage node manager 120 provides application linking and device status monitoring status. The storage node manager 120 initiates inquiries of the storage network and displays status-related events as they occur in the storage network.

Storage optimizer 130 collects a common set of metrics for all storage devices and all interconnect devices. Common metrics allow for comparison of performance of like resources. Common metrics for interconnect devices include total errors, invalid CRCs, invalid transmission words, link failures, primitive sequence protocol errors, received bytes and frames, and synchronization losses. Common metrics for storage devices include percentage of reads and writes from cache, read and write cache hits, and read and write operations.

Storage optimizer 130 collects performance metrics on selected resources (e.g., storage devices and interconnect devices) periodically, for example, every fifteen minutes. The collected metrics may then be held in storage, may be summarized or averaged, as appropriate, and the summarized or averaged performance data may be stored and subsequently displayed.

Performance data may be archived. For example, performance metrics may be collected every fifteen minutes, averaged to produce an hourly value, and the hourly values may be archived daily, weekly, or at other appropriate intervals.

Trend analysis is possible by using the averaged or summarized performance metrics. The manager can use the stored (archived) data to perform trend analysis. Such trend analysis can be used to predict when performance will degrade to an unacceptable level. The trend analysis can also be used to notify managers so that corrective action can be taken in time to prevent an unacceptable level of performance. Trend analysis may begin by establishing a baseline for the collected performance metrics. Alternatively, or in addition, a threshold value may be established for any of the performance metrics.

Performance charts can be used to display performance metrics. Performance charts may take the form of line graphs. A performance chart may show, for example, the number of read operations on a selected storage device over time.

Storage allocater 140 controls storage access and provides security by assigning logical units (LUNs) and share groups to specific hosts. Assigned LUNs cannot be accessed by any other hosts. Share groups allows multiple hosts to share the same read-write access. LUNs also can be assigned to LUN groups and associate LUN groups. The assignments that can be made are specified in assignment rules 150. FIG. 1F is an embodiment of the assignment rules 150, illustrating, for example, the aforementioned assignment of LUNs to LUN groups and associate LUN groups. The assignment of specific hosts and LUNs can be changed using the storage area manager server user interface 170.

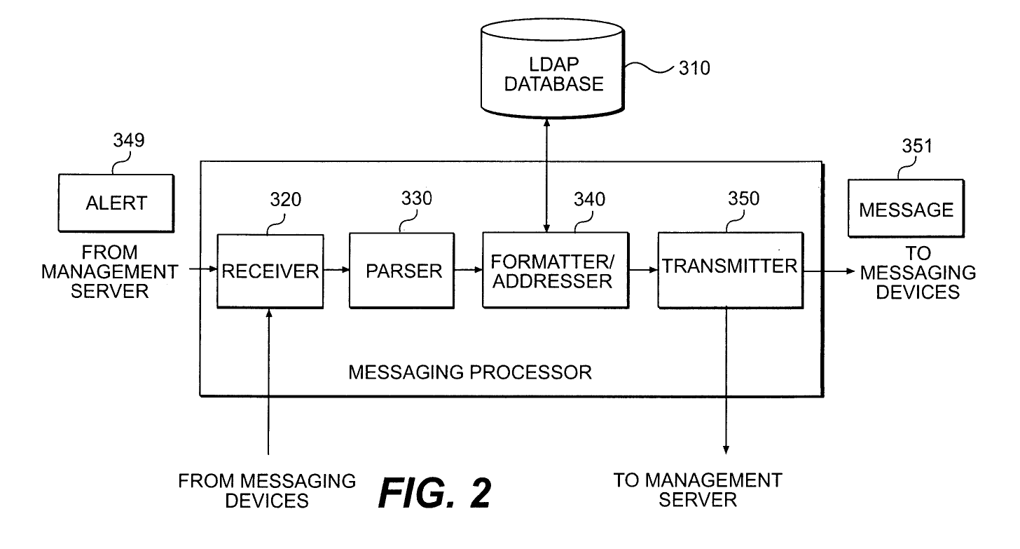

FIG. 2 is a block diagram of an embodiment of the message processor 300. The message processor 300 receives e-mail alerts from and sends commands to the management server 100, and sends messages to the messaging devices 400 and to the management server 100. The message processor 300 communicates with the LDAP database 310 to retrieve identification and contact information for system administrators and other individuals. The message processor 300 may initiate corrective actions automatically, that is, without specific direction from a system administrator. Additionally, the management server 100 may also initiate automatic corrective actions. Thus, the SAN system 10 may have at least two levels of automatic corrective actions: those directed by the management server 100 and those directed by the message processor 300. For either level of automatic corrective action, the message processor 300 may still provide an e-mail message to an appropriate messaging device 400. In the event an automatic corrective action is taken, the message provided to the messaging device may state what corrective action was taken.

As shown in FIG. 2, the message processor 300 includes receiver 320, parser 330, formatter/addresser 340, and transmitter 350. The receiver 320 is the first component of the message processor 300 that sees the e-mail alerts sent by the management server 100. The receiver 320 also receives reply messages from the messaging devices 400.

The parser 330 examines each of the e-mail alerts, determines what, if any action is required, initiates action in some circumstances, and determines what if any messages should be send to the messaging devices 400. The parser 330 also receives the reply messages from the messaging devices 400 and directs that actions specified in the reply messages are completed.

The formatter/addresser 340 determines a correct format for any outgoing notification messages 351, and identifies the primary and secondary addresses to use for such outgoing messages 351, based on data retained in the LDAP database 310.

The transmitter 350 receives the formatted/addressed messages from the formatter/addresser 340 and sends the messages 351 to the designated destination.

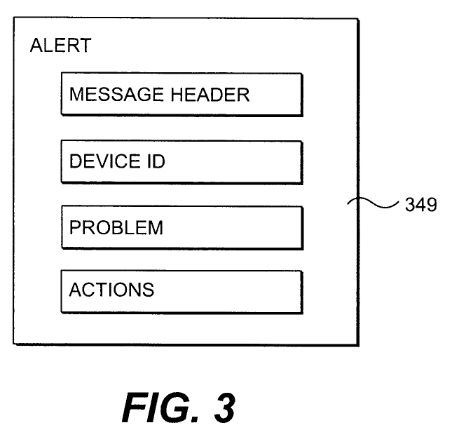

FIG. 3 illustrates an e-mail alert message 349 sent by the management server 100 and processed by the message processor 300. The message 349 may be a formatted e-mail message having designated fields. For example, the message 349 may include a message header, device identification (ID) section, a problem section, and an optional action section. The header section includes time and date information, and may include information related to the device that is the subject of the message. Information related to the device may, for example, identify the type of device such as tape storage or disk array, for example. The device ID section identifies the device that is the subject of the message by providing a unique device identification. The problem section may state the nature of the problem with the device. For example, the problem section could indicate that a tape storage is at 90 percent capacity. Finally, the optional actions section may indicate possible actions to correct the stated problem, such as route storage to another tape storage device. As will be described later, the optional actions section may be used to specify an intended corrective action that will be executed by the management server 100 upon expiration of a preset time period for the message processor 300 to reply to the message 349. Alternatively, or in addition, the optional actions section may be used to suggest corrective actions to be taken by the management server 100 in response to the problem stated in the problem section. When corrective actions are suggested in the message 349, the management server 100 is constrained from taking actions until directed to do so by the message processor 300. The allowed automatic actions to be executed by the management server 100 are specified in a database or table that may be provided and updated by the system administrator.

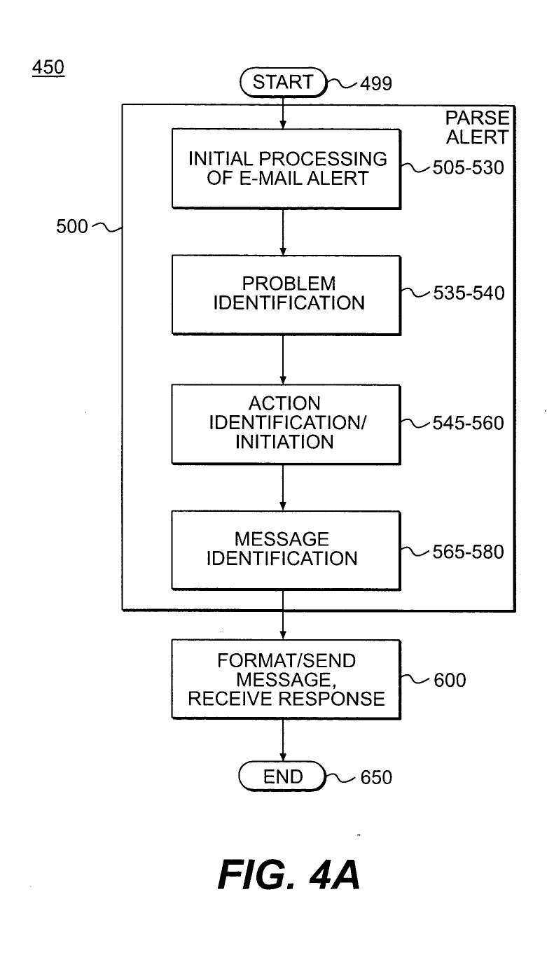

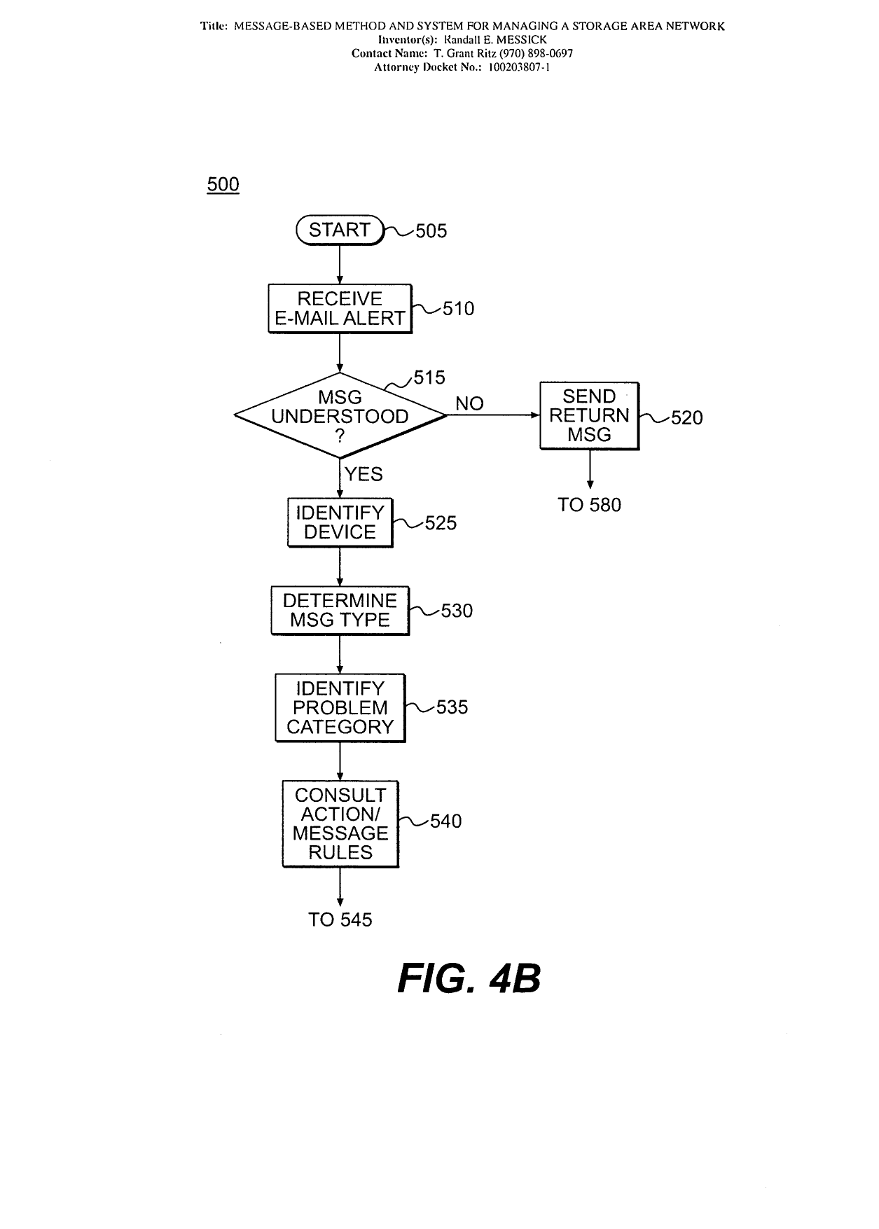

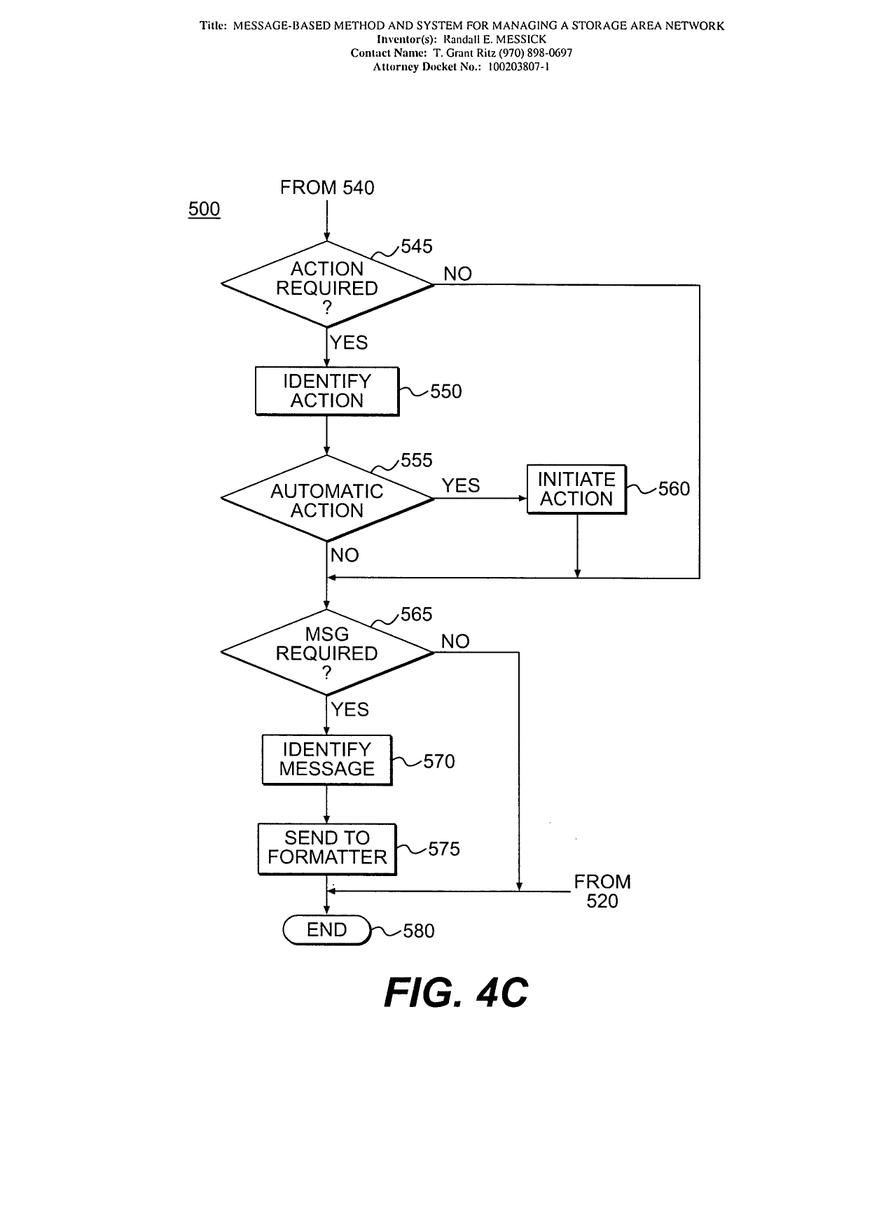

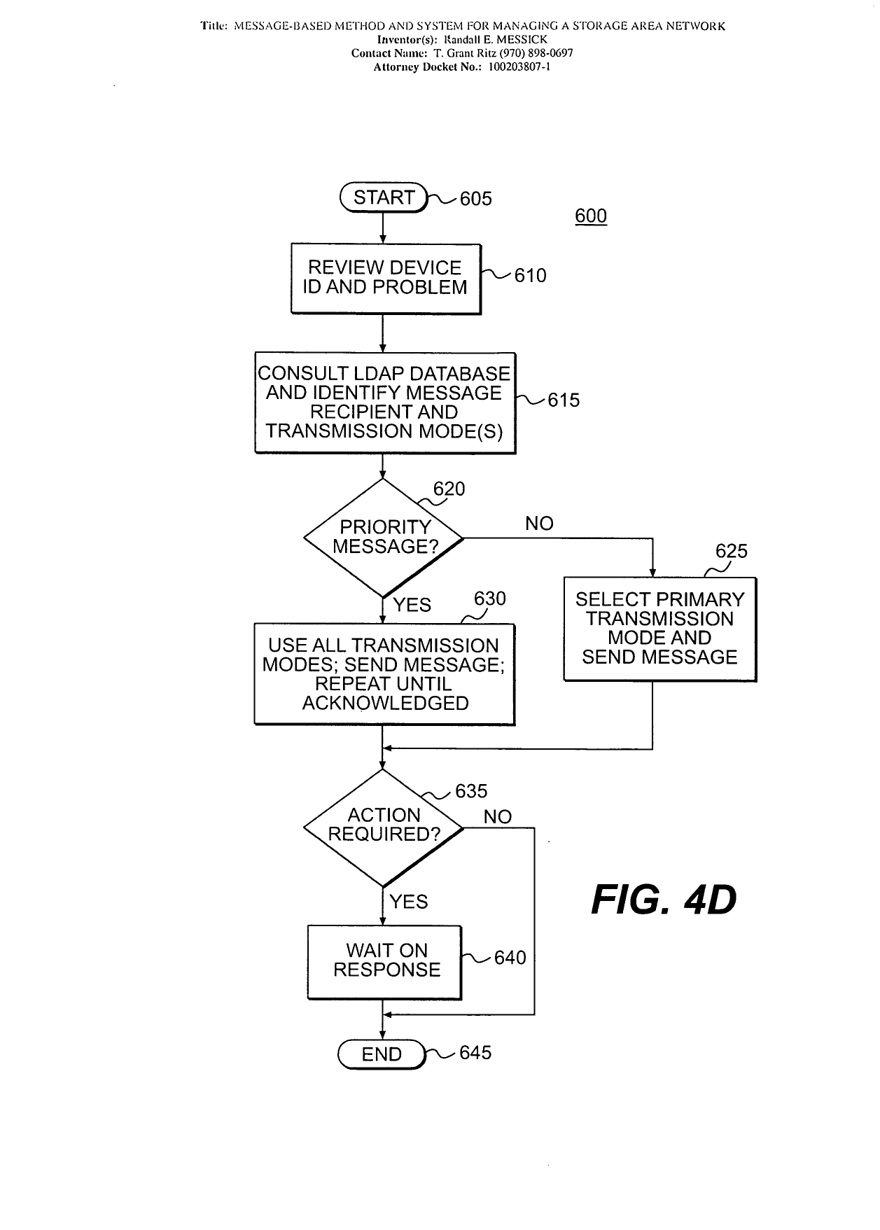

FIG. 4A is a block diagram of exemplary programs 450 executed by the message processor 300 to provide message-based management of the SAN system 10 of FIG. 1A. The programs 450 include parsing algorithm 500 and message formatting/addressing algorithm 600. The programs 450 begin with block 499. As will be described later in more detail, the message processor 300 receives e-mail alerts concerning the state of devices in the SAN system 10 from the management server 100. The message processor 300 uses the parsing algorithm 500 to read the e-mail alert, identify the affected device(s), identify (an in some cases initiate) corrective actions, and determine what, if any, notification messages should be sent. The message processor 300 uses the message formatting/addressing algorithm 600 to identify the communications means and the destination for the notification message. Once all required actions are either initiated, or a deliberate decision is made not to take corrective action, and once all notification messages have been sent (and optionally acknowledged), the programs 450 end, block 650.

FIGS. 4B-4C illustrate the message parsing algorithm 500 used by the message processor 300 in more detail. In FIG. 4B, the algorithm 500 begins (block 505) when the receiver 320 receives (block 510) the e-mail alert message 349 and forwards the message 349 to the parser 330. In block 515, the parser 515 reads the fields and sections of the message 349 to determine if the message is understood. For example, the message should state a problem that is appropriate to the device type and the specific device identified by the device ID. Otherwise, the parser 330 will not understand the message. Other message errors could be incomplete or blank mandatory fields or sections, for example. If the message is not understood, the algorithm proceeds to block 520, and the message processor 300 sends a message back to the management server 100 indicating that the e-mail alert 349 was received but was not understood. The algorithm 500 then proceeds to block 580.

In block 515, if the message 349 is understood, the algorithm 500 moves to block 525 and the parser 330 identifies the specific device that is the subject of the message 349 by reading the device ID section of the message 349. The parser 330 may then also determine the LUN, LUN group, share group, and host group to which the device is assigned, as appropriate. In block 530, the parser 330 determines the type of the message 349. Specifically, the parser 330 determines if the message requires automatic action by the management server 100, a decision by a system administrator, or simply notification to the system administrator. In block 535, the parser 330 determines a category of any problem stated in the message 349. For example, the message 349 may indicate a problem of over capacity with one of the tape libraries, and the problem category would be over capacity. Using the problem category as an entering argument, along with the device identification, and any group assignments, the parser 330, in block 540, consults a rules database or table of required/permitted actions and required messaging. For example, if a tape library is over capacity, the rules database may specify as possible options to bring a backup tape library on line and save data to the backup and to direct the affected host(s) to store to a direct attached storage (DAS). However, both options may not be available to all hosts. For example, host 1 in FIG. 1A may not have available a DAS, or may not have access to the backup tape library. The rules database may also specify that the action be taken automatically by the management server 100, in which case the message processor would so instruct the management server 100. Alternatively, the rules database may specify that such action must be approved by a system administrator, in which case the message 351 provided by the message processor 300 to one of the messaging devices 400 would list “bring backup tape library online” as a suggested corrective action. Once the parser 330 has consulted the rules database, the algorithm 500 moves to block 545.

In block 545, the parser 300 determines if a specific action or actions are required and possible in response to the stated problem. In this context, an action implies changing the state of one or more devices in the SAN system 10, as opposed to sending a message to a message administrator. Using the device identification, the parser 330 can determine if any of the suggested actions would not be applicable to the identified device, as, for example, when a host 12 does not have available a DAS. If no action is required, the algorithm 500 proceeds to block 565. If action is required, the algorithm 500 moves to block 550, and the possible actions are identified. Note that more than one action may be possible, and the parser 330 identifies each optional action. In block 555, the parser 330 determines if any of the identified optional actions are to be undertaken automatically, that is, without receipt of a reply message from a system administrator approving such action. If the identified optional action(s) are automatic, processing moves to block 560, and the parser 330 initiates the action(s). To initiate the action, the message processor 300 sends an e-mail reply message, or other formatted-message to the management server 100 directing the management server 100 to execute the identified action(s). Alternatively, the action may be executed automatically by the management server 100 upon expiration of a preset time period for the message processor 300 to respond to the e-mail alert message 349.

Following blocks 555 and 560, processing moves to block 565, and the parser 330 determines if a message should be sent to one or more of the messaging devices 400. A message will always be sent if a system administrator or other operator must make a decision to take a specific corrective action. A message may also be sent to inform the system administrator that no action was required, or that action was taken automatically by either the management server 100 directly, or at the direction of the message processor 330. In block 565, if no message is required, processing moves to block 580. Otherwise, processing moves to block 570. In block 570, the parser 330 determines the type of message to send, and identifies the information to be included in the message. For example, the processor 330 may determine that the message is only a notification message (that is, no action required, or action taken automatically) or that the message is an action message (that is, the message specifies one or more actions to be taken, or provides action alternatives). Next, in block 575, the parser 330 provides the information determined in block 570 to the formatter 340. Processing then moves to block 580 and ends. The parser 330 is then ready to process the next alert message.

FIG. 4D is a flowchart illustrating the message formatting/addressing algorithm 600 in more detail. Processing begins in step 605, when the formatter/addresser 340 (see FIG. 2) receives device information from the parser 330. In block 610, the formatter/addresser 340 reviews the device identification and the problem stated in the device information. In block 615, the formatter/addresser 340 consults the LDAP database 310 and identifies message recipients and transmission mode(s) for the notification message(s). Depending on the problem category, automatic or recommended action, and other device information, the formatter/addresser 340 will identify one or more recipients for the notification. In addition, the formatter/addresser 340 will identify transmission modes for the notification message, based on information provided in the LDAP database 310. In block 620, the formatter/addresser 340 determines if the notification message is to be a priority message. Factors that may lead to a priority message include if immediate corrective action is needed that requires the consent of a system administrator or operator, if an automatic corrective action initiated by the message processor 300 or the management server 100 requires immediate notification, and other events.

If the message is not to be a priority message, processing moves to block 625, and the formatter/addresser 340 selects a primary transmission mode and formats and sends the notification message to the transmitter 450 for transmission to the appropriate messaging device 400. In block 620, if the message is a priority message, the formatter/addresser 340 selects all available transmission modes, formats the notification message and sends the notification message to the transmitter 350 for transmission to the messaging devices 400. The formatter/addresser 340 repeats the priority notification message periodically until acknowledged by the message's intended recipient (e.g., a system administrator or system operator).

Following block 625 or 630, processing moves to block 635, and the formatter/addresser 340 determines if the notification message includes a section stating suggested corrective action(s) for approval by the system administrator or operator. If no approval is required by the message recipient to initiate action, processing moves to block 645 and ends. Otherwise, processing moves to block 640 and the message processor 300 waits for a reply message specifying and authorizing corrective action.

In formatting the notification message, the formatter/addresser 340 may list one or more action steps for approval. Some action steps requiring approval may be optional, some may be mutually exclusive, and some may be required to continue operation of the device identified in the alert message 349. In any event, the notification message may be formatted in such a manner that the message recipient need only “check the block” to approve the action(s) and to initiate a reply message back to the message processor 300.

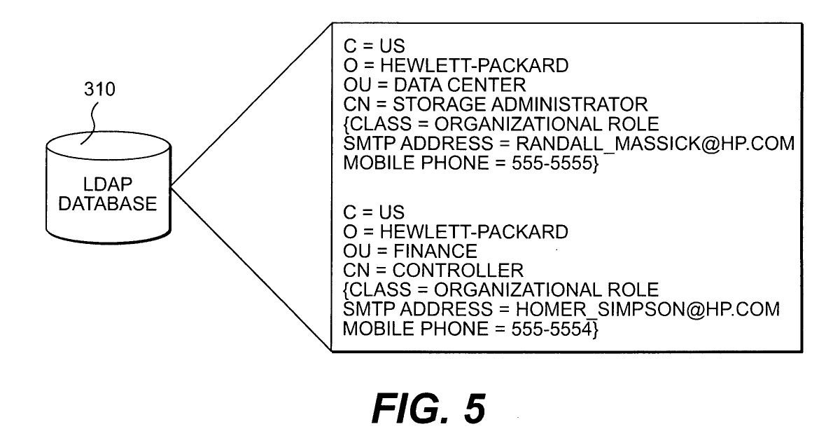

FIG. 5 is a diagram of the data structure of the lightweight directory access protocol database 310 used by the message processor 300. As shown in FIG. 5, data entered into the LDAP 310 includes an identification of individuals involved in supervising the maintenance and operation of the SAN system 10. Associated with each of the individuals are primary and secondary contact information, position, and other information needed by the message processor 300 to ensure that the appropriate messaging device 400 receives any required e-mail messages.

The above-described exemplary methods may be executed on a general purpose or special purpose computer (not shown). The execution is directed by a computer program product (not shown) including a computer-readable medium and computer-readable code embodied on the computer-readable medium. The computer readable medium may be a removable magnetic storage device, an removable optical storage device, a computer hard drive, and other devices capable of holding the computer-readable code. The computer-readable code is configured to cause a computer to execute the steps of receiving an alert related to a state of a device coupled to a storage area network (SAN) and parsing the alert to identify the state of the device. Parsing the alert includes determining a problem category, and determining action options, comprising consulting an action rules database. The steps executed by the computer further includes identifying action required in response to the identified state of the device, and identifying a notification message, wherein the notification message provides information related to the state of the device.

The message-based method and system described herein for managing a SAN eliminates many of the shortcomings of present methods and systems, including reducing the number of user interactions required to manage the SAN, particularly in terms of assigning storage, providing alerts, and notifying human users of the SAN when problems arise or when storage configurations should change. The description provided above is directed to exemplary embodiments of the method and system, and is not meant to limit the scope of the claims that follow. Various modifications and variations of the described method and system will be apparent to those of ordinary skill in the art without departing from the scope and spirit of the claims.

1. A message-based method for managing a storage area network (SAN), comprising:
receiving an alert related to a state of a device coupled to the SAN;
parsing the alert to identify the state of the device, comprising:
determining a problem category, and
determining action options, comprising consulting an action rules database;
identifying action required in response to the identified state of the device; and
identifying a notification message, wherein the notification message provides information related to the state of the device.

2. The method of claim 1, further comprising identifying an operator of the SAN to receive the notification message.

3. The method of claim 2, further comprising sending the notification message to the operator.

4. The method of claim 3, further comprising:
waiting on a response message from the operator, wherein the response message directs performance of one or more action steps; and
directing execution of the action steps.

5. The method of claim 4, wherein the information in the notification message includes one or more suggested action steps for execution.

6. The method of claim 1, further comprising directing performance of one or more automatic action steps.

7. The method of claim 1, wherein the information includes a report of automatic action steps completed.

8. The method of claim 1, wherein the notification message is one of an e-mail message, a voice message and a voice-to-text message.

9. A method for managing a storage area network (SAN), wherein a message processor receives alerts from a management server and sends notification messages to SAN operators, the method, comprising:
monitoring states of devices coupled to the SAN;
receiving an alert when a state of a device indicates a problem;
determining if the alert is understood, wherein if the alert is not understood, the message processor sends a return message to the management server;
identifying a device subject to the alert;
identifying a problem as indicated by the alert;
identifying action steps for responding to the problem;
identifying an operator to receive a notification message; and
formatting and sending the notification message.

10. The method of claim 9, wherein identifying the problem comprises:
identifying a problem category; and
consulting an action rules database.

11. The method of claim 9, wherein identifying action steps comprises:
determining if action is required;
identifying the action; and
determining if the action is automatic.

12. The method of claim 11, further comprising, if the action is automatic, initiating the action.

13. A message-based system for managing a storage area network (SAN), comprising:
a management server that monitors states of devices coupled to the SAN and sends alert messages based on the states; and
a message processor that receives the alert messages and sends notification messages, the message processor comprising:
a receiver that receives the alert messages,
a parser that analyzes the received alert messages,
a formatter/addresser that formats and addresses the notification messages, and
a transmitter that sends the notification messages to messaging devices.

14. The system of claim 13, further comprising an action rules database that specifies possible corrective actions, wherein the parser consults the database and uses a state of a device to determine action options.

15. The system of claim 14, wherein the possible corrective actions include actions to be initiated automatically by the message processor.

16. The system of claim 14, wherein the possible corrective actions include action options requiring approval of a system administrator receiving a notification message, and wherein the notification message includes the action options.

17. The system of claim 13, wherein the formatter/addresser formats the alert messages for receipt by one or more of a Web browser, a mobile phone, and a telephone.

18. The system of claim 13, wherein the management server initiates automatic corrective action based on a monitored state of a device, and wherein a notification message indicates the action taken by the management server.

19. The system of claim 13, wherein the alert messages are e-mail messages.

20. The system of claim 13, further comprising a lightweight directory access protocol (LDAP) database that specifies recipients of the alert messages and transmission modes and addresses.

21. A computer program product comprising a computer-readable medium and computer-readable code embodied on the computer-readable medium, the computer-readable code configured to cause a computer to execute the following steps:
comprising:
receiving an alert related to a state of a device coupled to a storage area network (SAN);
parsing the alert to identify the state of the device, comprising:
determining a problem category, and
determining action options, comprising consulting an action rules database;
identifying action required in response to the identified state of the device; and
identifying a notification message, wherein the notification message provides information related to the state of the device.

22. The computer program product of claim 21, the steps further comprising identifying an operator of the SAN to receive the notification message.

23. The computer program product of claim 21, the steps further comprising sending the notification message to the operator.

24. The computer program product of claim 23, the steps further comprising:
waiting on a response message from the operator, wherein the response message directs performance of one or more action steps; and
directing execution of the action steps.

25. The computer program product of claim 24, wherein the information in the notification message includes one or more suggested action steps for execution.

26. The computer program product of claim 21, the steps further comprising directing performance of one or more automatic action steps.

27. The computer program product of claim 21, wherein the information includes a report of automatic action steps completed.

28. A message-based system for managing a storage area network (SAN), comprising:
means for monitoring states of devices coupled to the SAN;
means for sending alert messages based on the states; and
means for receiving the alert messages and sending notification messages, the receiving means comprising:
means for analyzing the received alert messages, and
means for formatting and addressing the notification messages, wherein the notification messages are sent to messaging devices.

29. The system of claim 28, further means for specifying possible corrective actions, wherein the analyzing means consults the specifying means and uses a state of a device to determine action options.

30. The system of claim 29, wherein the possible corrective actions include actions to be initiated automatically by the receiving means.

31. The system of claim 29, wherein the possible corrective actions include action options requiring approval of a system administrator receiving a notification message, and wherein the notification message includes the action options.

32. The system of claim 28, wherein the formatting/addressing means formats the alert messages for receipt by one or more of a Web browser, a mobile phone, and a telephone.
